(19) United States
(12) Patent Application Publication
(10) Pub. No.: US 2015/0295798 A1
(43) Pub. Date: Oct. 15, 2015

(54) UNIVERSAL REPORTING SYSTEM

(71) Applicant: Caterpillar Inc., Peoria, IL (US)

(72) Inventor: Phillip A. Jones, Brisbane (AU)

(73) Assignee: Caterpillar Inc., Peoria, IL (US)

(21) Appl. No.: 14/729,074

(22) Filed: Jun. 3, 2015

(51) Int. Cl. H04L 12/26

(52) U.S. Cl. CPC H04L 43/065; H04L 43/08

(57) ABSTRACT

A universal reporting solution system for a dimensional data associated with a worksite management system is provided. The universal reporting solution system includes a receiving module coupled to a categorization module. The categorization module is configured to form independent metrics and derives additional metrics. The categorization module buckets the dimensional data within independent metrics and combines the bucketed dimensional data to obtain reporting information. The reporting information is further utilized to generate reports independent of an entity with which the reporting information is associated.

### TECHNICAL FIELD

The present disclosure relates to a universal reporting system, and more particularly to the universal reporting system operatively connected to a plurality of source systems to generate data reports associated with personnel, machine, and worksite operations.

### BACKGROUND

Different machines may be evaluated or monitored based on distinct parameters. Accordingly, reporting metrics for each of the machines are also different. This may lead to complex reporting structures associated with different machine types, adding to processing overheads in the system.

U.S. Pat. No. 7,139,754 describes a method of categorizing objects in which there can be multiple categories of objects and each object can belong to more than one category is described. The method defines a set of categories in which at least one category is dependent on another category and then organizes the categories in a hierarchy that embodies any dependencies among them. Each object is assigned to one or more categories in the set. A set of labels corresponding to all combinations of any number of the categories is defined, wherein if an object is relevant to several categories, the object must be assigned the label corresponding to the subset of all relevant categories. Once the new labels are defined, the multi-category, multi-label problem has been reduced to a multi-category, single-label problem, and the categorization task is reduced down to choosing the single best label set for an object.

### SUMMARY OF THE DISCLOSURE

In one aspect of the present disclosure, a universal reporting system for dimensional data associated with a worksite management system is provided. The dimensional data includes at least one of machine information, worksite information, personnel information, and a combination thereof. Further, the dimensional data is associated with an entity of the worksite management system. The universal reporting solution system includes a receiving module configured to connect to a plurality of sources. The plurality of sources is configured to provide the dimensional data in raw form. Additionally, a categorization module is coupled to the receiving module. The categorization module is configured to form a plurality of independent metrics for categorizing of the dimensional data and create a hierarchy of a plurality of additional metrics based on the plurality of independent metrics. Each of the plurality of additional metrics is derived from one or more of the plurality of independent metrics. The universal reporting solution further buckets the dimensional data in the raw form into the plurality of independent metrics. The bucketing of the dimensional data is performed irrespective of the entity with which the dimensional data is associated. The universal reporting solution also combines the bucketed dimensional data to derive reporting information based, at least in part, on the plurality of independent metrics and the hierarchy of the plurality of additional metrics, such that the reporting information is utilized to universally build reports independent of the entity with which the reporting information is associated.

Other features and aspects of this disclosure will be apparent from the following description and the accompanying drawings.

### BRIEF DESCRIPTION OF THE DRAWINGS

FIG. 1 is a block diagram of an exemplary environment for implementing the present disclosure, according to one embodiment of the present disclosure;

FIG. 2 is a block diagram of an exemplary universal reporting solution system, according to one embodiment of the present disclosure; and

FIG. 3 is a block diagram of an exemplary hierarchy of independent and additional metrics, according to one of the present disclosure.

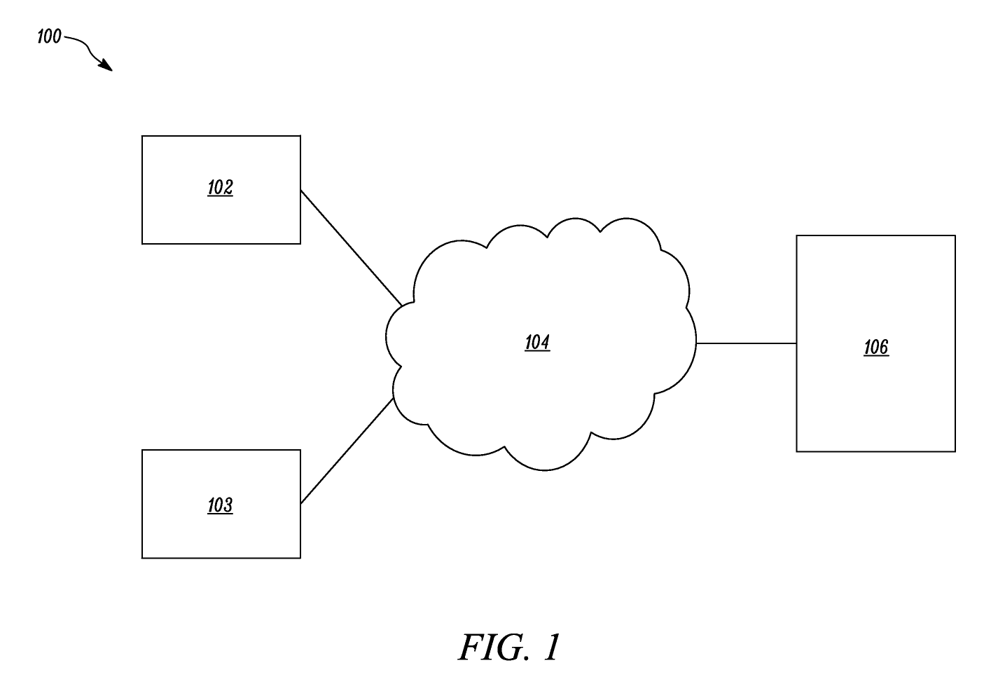

### DETAILED DESCRIPTION

Wherever possible, the same reference numbers will be used throughout the drawings to refer to the same or the like parts. With reference to FIG. 1, an exemplary environment 100 for implementing the present disclosure is depicted. In one example, the environment 100 may be employed across a plurality of worksites spanning different geographical locations, having a number of different machines deployed thereon. The machines may be configured to perform different tasks on the worksite, for example some machines may be used to transport material from one location to another on the worksite. The machines may include, but not limited to, a mining truck, a haul truck, an on-highway truck, an off-highway truck, an articulated truck, and the like. Further, the machines may also include a number of different loading machines configured to load the material onto the other machines. The type of loading machines may include, but not limited to, a conveyor, a large wheel loader, a track-type loader, a shovel, a dragline, a crane, and the like.

The environment 100 includes a plurality of sources 102, 103 associated with a worksite management system. The sources 102, 103 are associated with managing dimensional data associated with the worksite management system. For example, the sources 102, 103 may collect data related to machine information of different machines, worksite information related to the worksite on which the different machines operate, personnel information related to crew or designated work staff operating the different machines, or a combination thereof. In one embodiment, the sources 102, 103 may include, but not limited to, web services. Alternatively, the sources 102, 103 may be data servers or application servers. Accordingly, the dimensional data may include machine information, worksite information, personnel information, or a combination thereof. Further the dimensional data is associated with an entity of the worksite management system. The entity of the worksite management system includes for example, a machine, a specific worksite, a person associated with performing a given task, and so on. For example, the dimensional data associated with the worksite management system may include a set of permissions granted to an autonomous machine to use parts of a road network.

A person of ordinary skill in the art will appreciate that the sources 102, 103 described herein are exemplary in nature and do not limit the scope of the present disclosure. Further, the sources 102, 103 may additionally include other components and capabilities not described herein. Although only two sources 102, 103 are illustrated in the accompanying figures, the system may additionally include other sources having varied capabilities. The environment 100 may additionally include any number of systems. Further, the architecture and capabilities of these systems may vary without any limitation.

The sources 102, 103 may be communicably coupled to a universal reporting solution system 106 via a network 104. Examples of the network 104 may include, but are not limited to, a wide area network (WAN), a local area network (LAN), an Ethernet, Internet, an Intranet, a cellular network, a satellite network, or any other suitable network for transmitting data. In various embodiments, the network 104 may include a combination of two or more of the aforementioned networks and/or other types of networks known in the art. Further, the network 104 may be implemented as a wired network, a wireless network, or a combination thereof. Further, data transmission make take place over the network 104 with a network protocol such that the data transmission is in an encrypted format, any other secure format, or in any of a wide variety of known manners.

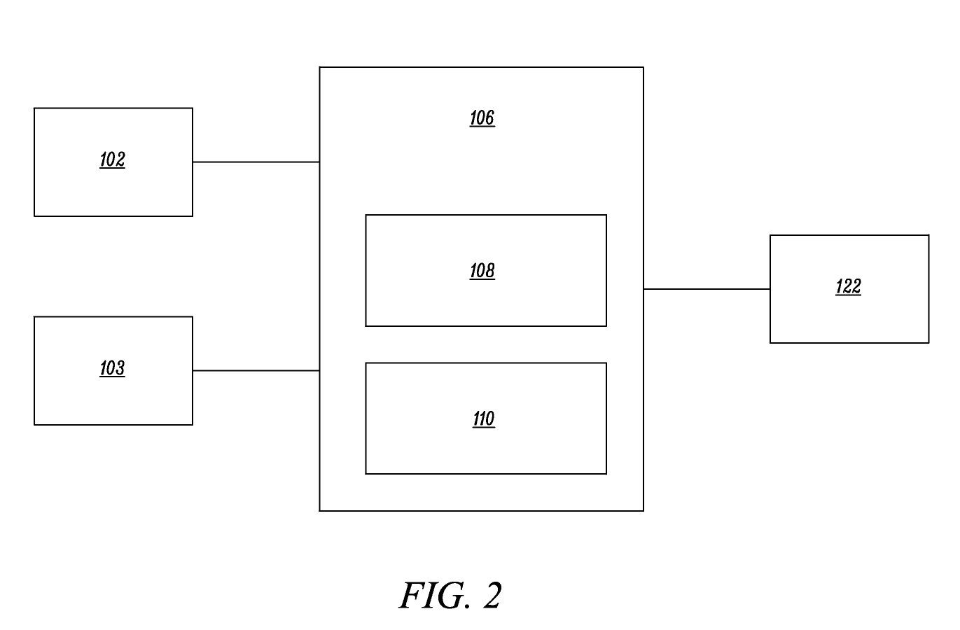

The present disclosure relates to the universal reporting solution system 106 configured to generate reporting information which may be utilized to form reports irrespective of the entity with which the dimensional data is associated with. Referring to FIG. 2 the universal reporting solution system 106 includes a receiving module 108. The receiving module 108 is configured to connect to the sources 102, 103.

The receiving module 108 receives the dimensional data in a raw form from the sources 102, 103. The dimensional data may be received by the receiving module 108 on a real time basis, periodic basis or on-demand basis, according to the application, the receiving module 108 may analyze different aspects of the dimensional data. As explained earlier, the dimensional data may be associated with a variety of entities. In one embodiment, the receiving module 108 may standardize the dimensional data.

The universal reporting solution system 106 also includes a categorization module 110. The categorization module 110 is configured to form a plurality of independent metrics associated with the dimensional data for categorizing the dimensional data based on content thereof. The independent metrics are parameters that can be used to broadly classify the dimensional data received from the sources 102, 103. The independent metrics may be predefined in such a manner that the definition of each of the independent metrics may be universally applied to the dimensional data irrespective of the entity to which the dimensional data pertains.

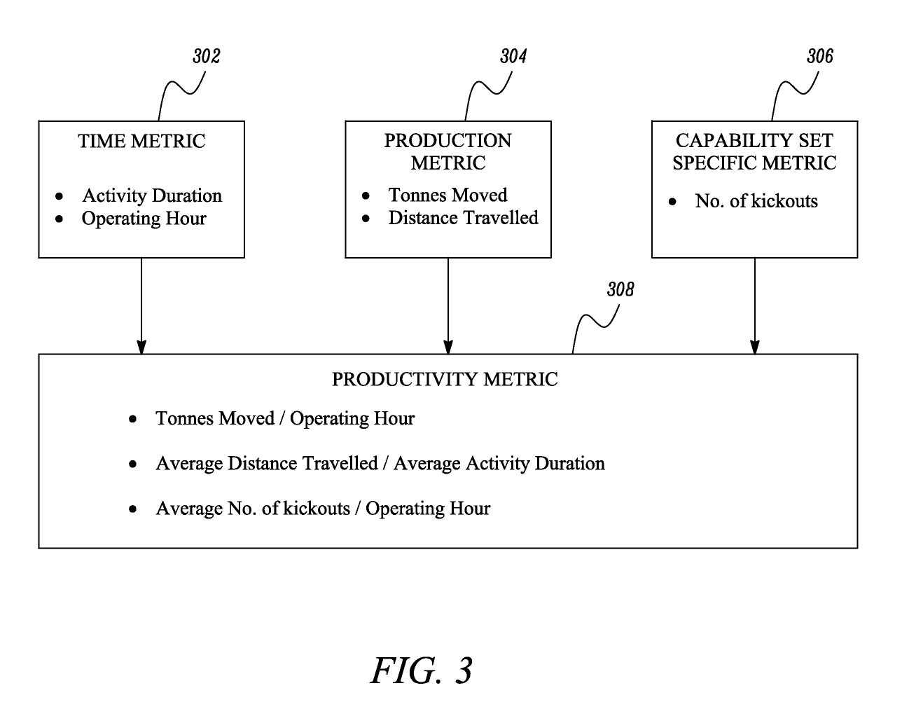

Further, the categorization module 110 may create a plurality of additional metrics. The additional metrics may be derived from one or more of the independent metrics, such that each of the additional metrics may be correlated to any of a combination of the independent metrics, a combination of independent and additional metrics, and so on. Accordingly, each of the additional metrics may form new parameters as per which the dimensional data may be classified. As in case of the independent metrics, the definition of each of the additional metrics may remain same for all the dimensional data, irrespective of the entity to which the dimensional data belongs. The independent and additional metrics may form a hierarchy of classification in the system, such that the incoming dimensional data in the raw form may be appropriately categorized based on the content of the dimensional data. Exemplary metrics will be explained in detail in connection with FIG. 3.

The categorization module 110 may receive the dimensional data from the receiving module 108. Further, the categorization module 110 may bucket the dimensional data into the independent metrics based on the content of the dimensional data. This bucketing of the dimensional data may take place independent of the entity to which the dimensional data belongs. Additionally, based on the additional metrics, the bucketed dimensional data may be combined in order to derive information from the bucketed dimensional data as per the additional metrics.

The universal reporting solution system 106 may be communicably coupled to a reporting module 122. The reporting module 122 may receive the subsets of the bucketed and combined dimensional data associated with the independent and/or additional metrics respectively, to form reporting information. The reporting information may be utilized to universally build reports by the reporting module 122. The reporting module 122 generates the reports that are independent of the entity with which the reporting information is associated. For example the reporting module 122 may generate an efficiency report for different types of work machines using the dimensional data such as time consumed, energy absorbed, man power, and the like.

FIG. 3 is a schematic diagram illustrating exemplary independent and additional metrics along with exemplary data. As shown, the independent metrics may include, but not limited to, time metric 302, production metric 304, and capability set specific metric 306 (hereinafter interchangeably referred as independent metrics 302, 304, 306). These independent metrics 302, 304, 306 form individual buckets or pools in which the dimensional data received from the sources 102, 103 (see FIG. 1) may be categorized. Additionally, the categorization module 110 may create the additional metric, in this case, productivity metric 308 (hereinafter interchangeably referred as additional metric 308) by combining the independent metrics 302, 304, 306.

Based on the content of the dimensional data, the categorization module 110 may bucket the dimensional data into the respective independent metric 302, 304, 306. As shown, in one exemplary scenario, the categorization module 110 buckets information related to “activity duration” within the worksite and “operating hour” of the entity within the time metric 302. Similarly, the dimensional data of tonnes of material moved or “tonnes moved” by the entity and “distance travelled” by the entity is bucketed into the production metric. The categorization module 110 combines the information bucketed into the independent metrics 302, 304, 306 to derive additional information as per the additional metric 308. As shown, the categorization module 110 combines information related to “tonnes moved” of the production metric 304 and “operating hour” of the time metric 302 to form “tonnes moved per operating hour” of the productivity metric 308.

Similarly, the categorization module 110 combines information related to average “distance travelled” by the entity of the production metric 304 and average “activity duration” of the time metric 302 to form information related to “average distance travelled per average activity duration” of the productivity metric 308. Additionally, the categorization module 110 combines information related to “number of kickouts” of the capability set specific metric 306 and the “operating hour” of the time metric 302 to form information related to “average number of kickouts per operating hour” of the productivity metric 308.

One of ordinary skill in the art will appreciate that when calculating the data associated with the time metric 302 or the productivity metric 308 for a specific machine, the “operating hour” may be computed as a wall clock or calendar time, may be specific to a mine calendar time, or may be based on an internal clock time associated with the machine. It should be noted that the independent and additional metrics 302, 304, 306, 308 and exemplary data described herein do not limit the scope of the present disclosure. Other categories and definitions may be utilized for the classification of the dimensional data based on the application. Accordingly, the hierarchy of the metrics will vary.

The universal reporting solution system 106 may embody a single microprocessor or a plurality of microprocessors for receiving data from the plurality of sources 102, 103. Numerous commercially available microprocessors may be configured to perform the functions of the universal reporting solution system 106. It should be appreciated that the universal reporting solution system 106 may embody an electronic controller capable of extracting and analyzing the dimensional data associated with different entities.

A person of ordinary skill in the art will appreciate that the universal reporting solution system 106 may additionally include other components and may also perform other functions not described herein. Further, the functionality of the universal reporting solution system 106 described herein is exemplary, and the universal reporting solution system 106 may additionally perform other operations on the source data from the plurality of sources 102, 103 to generate the reporting information.

### INDUSTRIAL APPLICABILITY

The present disclosure relates to the universal reporting solution system 106 that utilizes an information hierarchy based on defined independent and additional metrics. The hierarchy of the independent and dependent metrics allows for easy and simple categorization and derivation of the reporting information associated with each of the metrics. By forming a relation between the independent and additional metrics, appropriate information may be derived from the bucketed dimensional data. Hence, a structure is provided for generating of metric related reports for various entities, for example, drill reports, truck reports, shovel reports, and so on, such that the structure of the metrics enables for construction of reports across all machine types.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A universal reporting solution system for dimensional data associated with a worksite management system, the dimensional data including at least one of machine information, worksite information, personnel information, and a combination thereof, such that the dimensional data is associated with an entity of the worksite management system, the universal reporting solution system comprising:
a receiving module configured to connect to a plurality of sources, the plurality of sources configured to provide the dimensional data in raw form; and
a categorization module coupled to the receiving module, the categorization module configured to:
form a plurality of independent metrics for categorizing of the dimensional data;
create a hierarchy of a plurality of additional metrics based on the plurality of independent metrics, wherein each of the plurality of additional metrics is derived from one or more of the plurality of independent metrics;
bucket the dimensional data in the raw form into the plurality of independent metrics, wherein the bucketing of the dimensional data is performed irrespective of the entity with which the dimensional data is associated; and
combine the bucketed dimensional data to derive reporting information based, at least in part, on the plurality of independent metrics and the hierarchy of the plurality of additional metrics, such that the reporting information is utilized to universally build reports independent of the entity with which the reporting information is associated.
